(19) United States
(12) Patent Application Publication
(10) Pub. No.: US 2025/0111062 A1
(43) Pub. Date: Apr. 3, 2025

(54) GENERATING AUTOMATED WORKFLOWS ASSOCIATED WITH LOCAL ADMINISTRATOR RIGHTS USING ARTIFICIAL INTELLIGENCE TECHNIQUES

(71) Applicant: Dell Products L.P., Round Rock, TX (US)

(72) Inventors: Vivek Bhargava, Bangalore (IN); Mayank Kapoor, Bangalore (IN); Furkan Mohd Nisar, Ambedkar Nagar (IN); Dinesh Koppada, Bengaluru (IN)

(21) Appl. No.: 18/374,811

(22) Filed: Sep. 29, 2023

(51) Int. Cl. G06F 21/60

(52) U.S. Cl. CPC G06F 21/604; G06F 2221/2141

(57) ABSTRACT

Methods, apparatus, and processor-readable storage media for generating automated workflows associated with LAR using artificial intelligence techniques are provided herein. An example computer-implemented method includes obtaining data pertaining to a first set of software application(s) in association with at least one user device; identifying, by processing, using artificial intelligence techniques, data associated with one or more user devices related to the at least one user device, a second set of software application(s) related to at least a portion of the first set of software application(s); generating one or more automated workflows comprising LAR granted for the at least one user device, wherein the automated workflow(s) pertain to one or more operations to be carried out in connection with the at least one user device and the first set of software application(s) and/or the second set of software application(s); and performing one or more automated actions based on the automated workflow(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Commonly, users need one or more applications to be installed on certain devices (e.g., newly hired employees needing a host of applications to be installed on enterprise-issued devices before the employees can start to contribute to particular enterprise efforts). Additionally, such installations can often require administrator rights, which the users may not possess, and restrictions related to certain applications and/or particular devices. However, conventional software management techniques typically require time-consuming and resource-intensive procedures that limit the users' ability to carry out their primary tasks.

### SUMMARY

Illustrative embodiments of the disclosure provide techniques for generating automated workflows associated with local administrator rights (LAR) using artificial intelligence techniques.

An exemplary computer-implemented method includes obtaining data pertaining to a first set of one or more software applications in association with at least one user device. The method also includes identifying, by processing, using one or more artificial intelligence techniques, data associated with one or more user devices related to the at least one user device, a second set of one or more software applications related to at least a portion of the first set of one or more software applications. Further, the method includes generating one or more automated workflows including one or more local administrator rights granted for the at least one user device, wherein the one or more automated workflows pertain to one or more operations to be carried out in connection with the at least one user device and at least one of the first set of one or more software applications and the second set of one or more software applications. The method additionally includes performing one or more automated actions based at least in part on the one or more automated workflows.

Illustrative embodiments can provide significant advantages relative to conventional software management techniques. For example, problems associated with time-consuming and resource-intensive procedures are overcome in one or more embodiments through generating automated workflows associated with LAR using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for generating automated workflows associated with LAR using artificial intelligence techniques in an illustrative embodiment.

FIG. 2 shows an example portion of a user association dictionary in an illustrative embodiment.

FIG. 3 shows example pseudocode for creating a data frame of employee features in an illustrative embodiment.

FIG. 4 shows example pseudocode for recommending applications and creating corresponding LAR for a given employee in an illustrative embodiment.

FIG. 5 is a flow diagram of a process for generating automated workflows associated with LAR using artificial intelligence techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

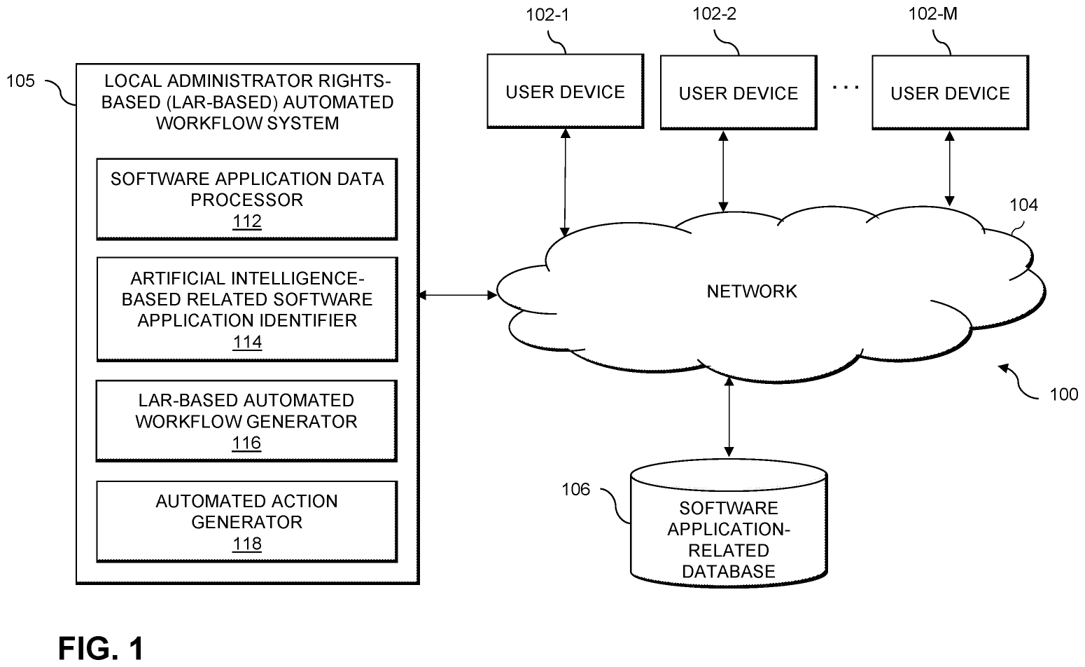

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is LAR-based automated workflow system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, LAR-based automated workflow system 105 can have an associated software application-related database 106 configured to store data pertaining to software applications required for certain tasks and/or jobs, software applications used by certain users and/or certain types of users, LAR associated with various software applications, etc. In one or more embodiments, software application-related database 106 can maintain information pertaining to certain software applications (e.g., software applications commonly used across a given enterprise), such information including, for example, version number information, which helps in updating and/or replacing older and/or deprecated versions of certain software applications from user devices.

The software application-related database 106 in the present embodiment is implemented using one or more storage systems associated with LAR-based automated workflow system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with LAR-based automated workflow system 105 are one or more input-output devices, which illustratively comprise keyboards, displays or other types of input-output devices in any combination. Such input-output devices can be used, for example, to support one or more user interfaces to LAR-based automated workflow system 105, as well as to support communication between LAR-based automated workflow system 105 and other related systems and devices not explicitly shown.

Additionally, LAR-based automated workflow system 105 in the FIG. 1 embodiment is assumed to be implemented using at least one processing device. Each such processing device generally comprises at least one processor and an associated memory, and implements one or more functional modules for controlling certain features of LAR-based automated workflow system 105.

More particularly, LAR-based automated workflow system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows LAR-based automated workflow system 105 to communicate over the network 104 with the user devices 102, and illustratively comprises one or more conventional transceivers.

The LAR-based automated workflow system 105 further comprises software application data processor 112, artificial intelligence-based related software application identifier 114, LAR-based automated workflow generator 116, and automated action generator 118.

It is to be appreciated that this particular arrangement of elements 112, 114, 116 and 118 illustrated in the LAR-based automated workflow system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for generating automated workflows associated with LAR using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, LAR-based automated workflow system 105 and/or software application-related database 106 can be on and/or part of the same processing platform.

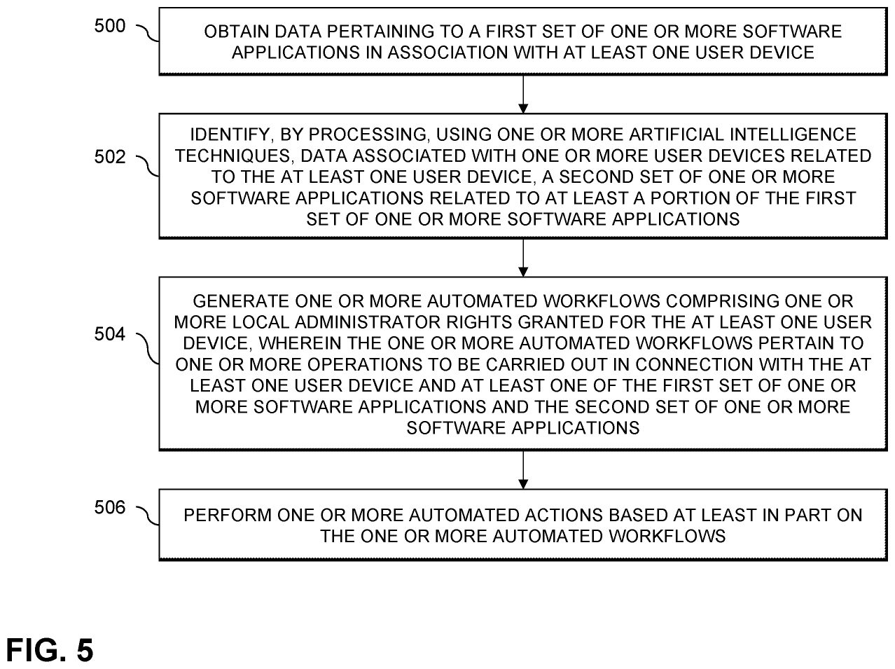

An exemplary process utilizing elements 112, 114, 116 and 118 of an example LAR-based automated workflow system 105 in computer network 100 will be described in more detail with reference to the flow diagram of FIG. 5.

As further detailed herein, using LAR-based automated workflow system 105, one or more embodiments can include creating groupings of user personas and roles, software applications, and data sources for installing, updating and/or replacing such software applications.

As used herein, providing local administrator rights to a user refers to granting to the user, without the need for administrator action and/or information such as an administrator password, control over at least one user device (e.g., a mobile device assigned to and/or operated by the user, a computer assigned to and/or operated by the user, etc.) with respect to carrying out one or more functions in connection with the at least one user device (e.g., adding and/or removing software applications to/from the at least one user device, changing device settings such as network configuration, power settings, etc., adding and/or removing one or more printers to/from the at least one user device, etc.).

Accordingly, at least one embodiment includes generating automated workflows associated with LAR using artificial intelligence techniques. As noted herein, example situations wherein devices need to set up and/or configured include employees being hired and/or onboarded by enterprises, users needing to migrate to a new device (e.g., a new laptop), devices needing to be preconfigured for certain specialized domains (e.g., education or medical industries), etc. In such situations, one or more embodiments include reducing and/or minimizing the need for user intervention in setting up and/or configuring devices, while reducing and/or minimizing risks associated with users being in an elevated access state. Such an embodiment includes creating one or more LAR packages for a particular group of applications based at least in part on user persona data, wherein such a LAR package (which can comprise one or more automated workflows) can be executed (e.g., in real time) by a user's device and processed (e.g., matched) when the user is attempting to install at least one particular application package.

As detailed herein, in connection with one or more embodiments, a LAR package refers to a software and/or computer-related utility designed to manage and control the assignment of local administrator rights on user devices within at least one network (e.g., in an enterprise or other organization). By way merely of example, consider an enterprise with a network of 500 user devices spread across multiple locations, and the enterprise wishes to ensure that only authorized staff can have local administrator rights on these user devices. Such staff can install and configure the package on their management server, and integrate the package with an active directory for users and group management. Additionally, users tagged as administrators can be placed into a dedicated active directory group referred to as “local administrators.” Also, a local administrator rights tool can be configured to grant local administrator rights only to members of the “local administrators” group.

Continuing with the above example, the given staff can use the local administrator rights tool to remotely deploy and configure local administrator rights on all or some of the 500 user devices. The staff ensures that only members of the “local administrators” group have these rights, and the tool enforces the enterprise's policy that only authorized staff can be added or removed from the “local administrators” group, preventing unauthorized changes. The tool also provides security measures to protect against unauthorized access, ensuring that local administrator rights are maintained securely.

Such a tool can be implemented at least in part as a standalone executable file, wherein such a file can be run directly on a user device's operating system without the need for additional software. Common programming languages for creating such an executable file can include C++, C#, etc., and some tools can be implemented as script files that are executed by scripting interpreters. For example, batch files (.bat) can be used for simple scripts, PowerShell scripts (.ps1) can be used for administrative tasks, and shell scripts (.sh) can be used for scripting on Unix-based systems.

By way merely of example, in the case of a laptop refresh wherein a user needs to clone a previous set of software, at least one embodiment can include generating and/or implementing a LAR package which facilitates and/or enables the user of the laptop to clone a particular set of software to the laptop. By way of additional example, in the case of software upgrades being needed for a device, at least one embodiment can include generating and/or implementing a LAR package which facilitates and/or enables the user of the device to automatically update the particular software on the device without asking a separate entity for LAR access.

Accordingly, and as further detailed herein, one or more embodiments include creating personalized workflows for particular users and/or devices to streamline device configuration processes and suggesting software recommendations to one or more such users.

Such an embodiment includes obtaining and/or collecting data from various sources (e.g., multiple heterogenous data sources) to construct a workflow management system. For example, one or more embodiments include collecting and curating a list of applications required for a particular user and/or a particular device (e.g., a new hire within an enterprise), wherein such a list is also referred to herein as a user personalization dictionary. Generating such a user personalization dictionary can include leveraging information technology management software and/or related inventory database information to identify software that similar users (e.g., new hires in the same department or team) are installing and/or having installed on their devices. In at least one embodiment, similar users can be searched for and/or identified on the basis of, e.g., user persona information such as job role, technical background, experience level, etc.

More specifically, in determining persona information for a given user (e.g., a new hire), at least one example embodiment can include determining and/or identifying the job title and department of the given user, wherein such information can provide insights into the user's role(s), responsibilities, and type of software that may be required for the user to carry out corresponding tasks. Such an example embodiment can also include determining and/or identifying the experience level of the given user, which can assist in understanding the user's proficiency with different types of software applications (also referred to herein simply as applications) and/or one or more specific needs of the user. Further, such an example embodiment can include determining and/or identifying the job function of the given user, which can include identifying specific tasks to be carried out by the user, which can facilitate a determination as to which software applications are needed and/or helpful for user's work.

Additionally, in one or more embodiments, metadata can be used in constructing a workflow management system. Such metadata can include, for example, application inventory data, which can comprise metadata about the software applications installed on the devices of similar users (e.g., team members), including metadata such as application names, versions, installation dates, usage statistics, etc. Other such metadata used in constructing a workflow management system can include application usage data, which can comprise metadata pertaining to how users interact with different applications, including usage patterns, frequency of use information, specific features accessed, etc. Analyzing such metadata can help, for example, in identifying common preferences and/or usage patterns for specific user roles and/or functions. Also, other such metadata used in constructing a workflow management system can include application dependencies of installed applications, such as libraries, frameworks, and/or plugins required by each application. Such information can assist in understanding interdependencies between applications and their potential impacts on compatibility and/or conflicts.

As such, one or more embodiments include determining a user personalization dictionary, such as detailed above, by utilizing characteristics of a user in question (e.g., a new hire being onboarded by an enterprise), wherein such characteristics can include job domain, job function, title, and other software applications actively being used by similar users (e.g., other users in the enterprise and/or within a same team of the enterprise).

Additionally, at least one embodiment also includes generating a user association dictionary of software applications used by and/or installed for other existing users. In generating a user association dictionary, such an embodiment can include identifying commonly used software applications across user personas within the organization, as well as identifying frequently installed software applications on the devices of similar users to a given user (e.g., team members of a newly hired user).

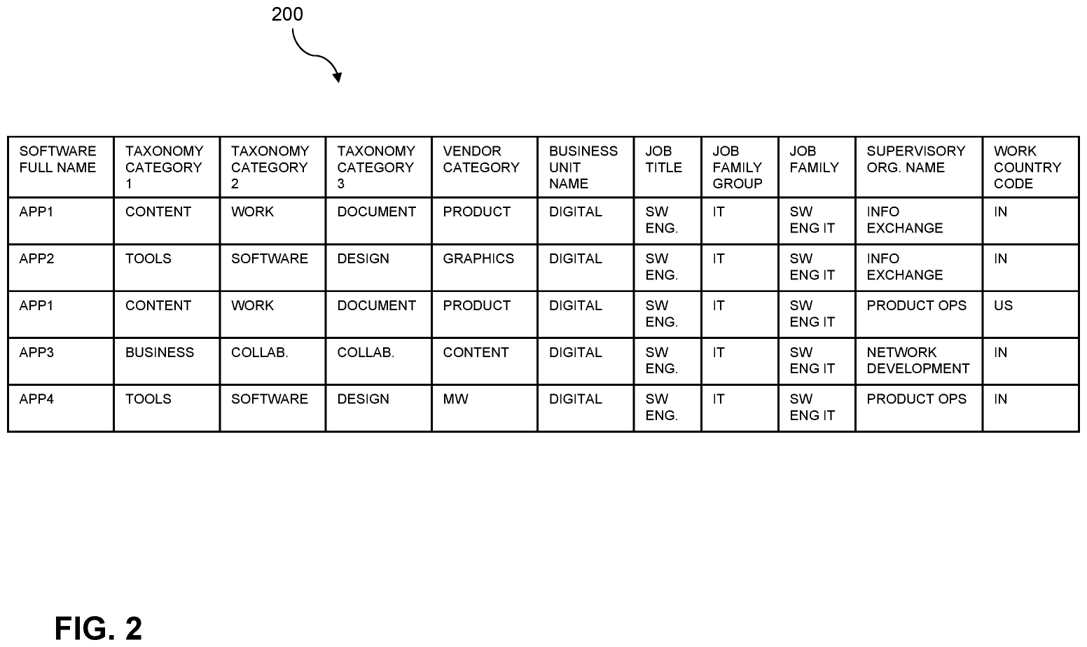

FIG. 2 shows an example portion of a user association dictionary 200 in an illustrative embodiment. By way of illustration, the example portion of user association dictionary 200 includes identification of the full name of given software applications, various taxonomy categories associated with the software applications, the vendor category of the software applications, the name of the business unit associated with the software applications, job title(s) associated with the software applications, the job family group(s) associated with the software applications, the job family associated with the software applications, the name of the supervisory organization(s) associated with the software applications, and the code of the work country associated with the software applications.

As used above and herein, job family group and job family are terms used to classify and categorize job positions within an enterprise or other organization. Specifically, a job family group is a broader category that encompasses several related job families (e.g., job families that share a common set of skills, competencies, and/or characteristics but may have some differences in connection with specific roles and/or responsibilities), and a job family is a more specific category that groups together job positions that have similar job duties, skills, and/or responsibilities.

Referring again to FIG. 2, creating a user association dictionary (such as the example portion illustrated in FIG. 2) can include defining various user personas and roles (e.g., departments, teams, job titles, etc.) within an enterprise or other organization, wherein each persona or role may have unique software application needs. Also, creating a user association dictionary can additionally include using one or more data sources (e.g., information technology (IT) management tools, software inventory reports, etc.) to identify and list installed software applications on one or more user devices as well as software applications that are commonly used and/or installed across user personas. In one or more embodiments, creating a user association dictionary can further include determining and/or providing persona-specific insights relating, e.g., to preferences of each user persona. For example, such insights might include an indication that a sales team relies heavily on email software applications, a marketing team commonly uses graphic design and/or web development software applications, an IT department requires the use of specialized IT management tools, a customer support uses live chat applications, and a finance department uses financial analysis tools. Additionally, at least one embodiment includes determining frequency of installation data, such as identifying how frequently each of one or more software applications is installed on given team members' devices.

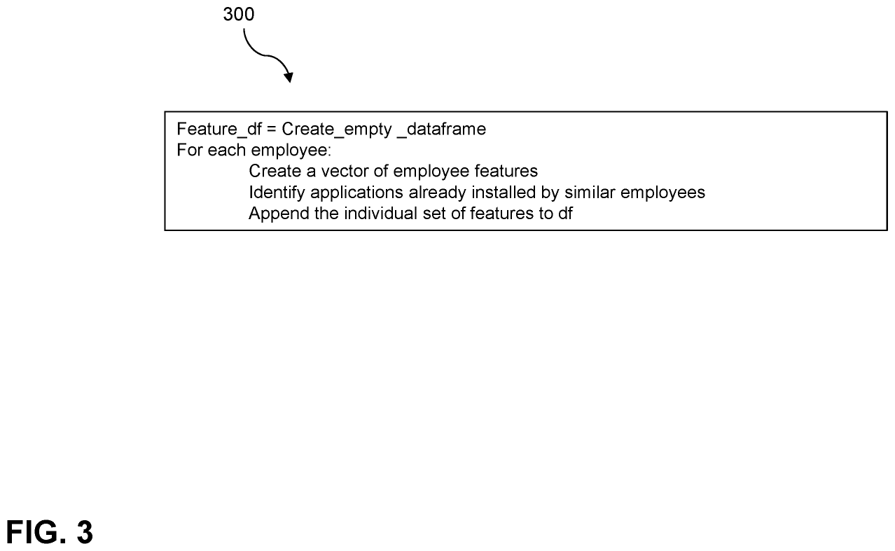

FIG. 3 shows example pseudocode for creating a data frame (df) of employee features in an illustrative embodiment. In this embodiment, example pseudocode 300 is executed by or under the control of at least one processing system and/or device. For example, the example pseudocode 300 may be viewed as comprising a portion of a software implementation of at least part of LAR-based automated workflow system 105 of the FIG. 1 embodiment.

The example pseudocode 300 illustrates initiating a feature data frame (feature_df) as an empty data frame. Also, for each employee within at least a portion of a given enterprise, example pseudocode 300 includes creating a vector of employee features (e.g., job title, department, experience level, job function, etc.), identifying applications already installed by similar employees (based, for example, at least in part on employees associated with similar features), and appending the individual set of features to the empty data frame.

It is to be appreciated that this particular example pseudocode shows just one example implementation of creating a data frame of employee features, and alternative implementations can be used in other embodiments.

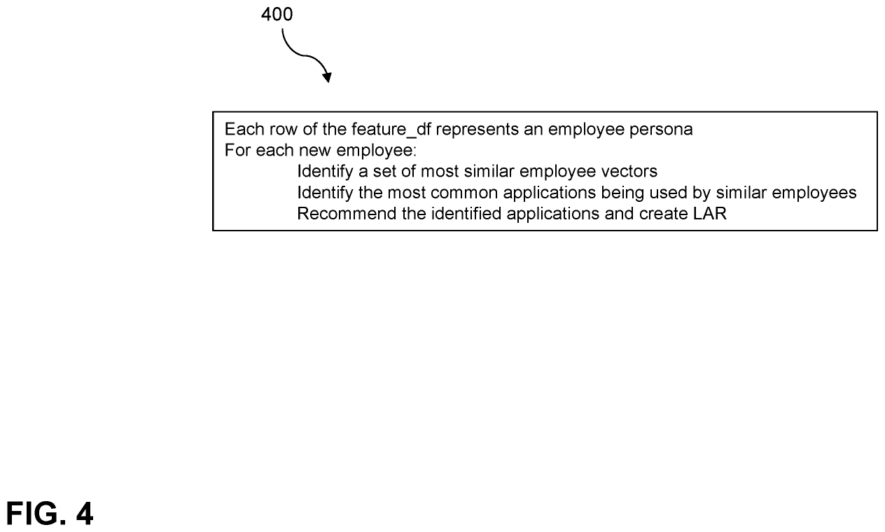

FIG. 4 shows example pseudocode for recommending applications and creating corresponding LAR for a given employee in an illustrative embodiment. In this embodiment, example pseudocode 400 is executed by or under the control of at least one processing system and/or device. For example, the example pseudocode 400 may be viewed as comprising a portion of a software implementation of at least part of LAR-based automated workflow system 105 of the FIG. 1 embodiment.

The example pseudocode 400 illustrates assuming and/or denoting that each row of a feature data frame (feature_df) such as created, for example, in connection with example pseudocode 300 in FIG. 3, represents an employee persona. Also, example pseudocode 400 illustrates, for each new employee of a given enterprise (e.g., the same given enterprise detailed in connection with example pseudocode 300 in FIG. 3), identifying a set of most similar employee vectors (e.g., vectors associated with other employees within the given enterprise), identifying the most common applications being used by similar employees (based, e.g., at least in part on the identified set of most similar employee vectors), and recommending the identified applications and creating LAR corresponding thereto for the new employee and/or at least one user device associated with the new employee.

It is to be appreciated that this particular example pseudocode shows just one example implementation of recommending applications and creating corresponding LAR for a given employee, and alternative implementations can be used in other embodiments.

By way merely of illustration, consider an example enterprise use case which involves a laptop refresh for a given employee. In such an example use case, the employee has to submit a first laptop to an IT support entity and/or system. Once the employee receives a second (e.g., new) laptop, the employee needs to install and/or reinstall applications previously installed on the first laptop, wherein such applications are needed for the employee's tasks and/or activities. Accordingly, at least one embodiment includes removing friction involved in the employee obtaining installation approvals for the necessary applications by automatically creating and implementing LAR corresponding specifically to those installations on the second laptop (and optionally performing one or more related tasks).

By way of further illustration, consider an example consumer use case which involves hospital activities. In such an example use case, hospitals typically encompass a variety of user roles (e.g., reception, nursing stations, doctors, etc.). Also, the users associated with these different roles commonly require different applications for carrying out respective tasks. Accordingly, instead of giving all such users full administrator rights to install any application, at least one embodiment includes creating automated workflows of LAR for installing applications (and optionally performing one or more related tasks) specific for each user role.

Further, one or more embodiments include suggesting one or more application recommendations by generating and/or processing a list of substitute and/or complimentary applications to a given set of software applications to be installed on a given user's device. Such an embodiment can include leveraging one or more software definitional databases and/or information pertaining to applications installed in particular user devices to create an information association model using similarity techniques such as, for example, cosine similarity, to identify the most similar complimentary and/or substitute applications for each software application installed or to be installed on the given user device(s). Leveraging software definitional databases can include processing information about various software applications, including application attributes, application features, application functionalities, and/or other relevant metadata.

Generating and/or processing a list of substitute and/or complimentary applications can also include using automatically generated content about applications by leveraging one or more large language models (LLMs) such as, e.g., bidirectional encoder representations from transformers (BERT), generative pretrained transformers (GPTs), etc. At least one embodiment can also include utilizing vector representations, wherein application names as well as automatically generated content and software definitions of given applications are represented as vectors using language models. Such language models can include, for example, one or more LLMs such as one or more sentence-transformers models (e.g., all-MiniLM-L6-v2 and/or all-mpnet-base-v2), one or more global vectors for word representation, etc. In such an embodiment, each component of a given vector can correspond to a specific feature or attribute of the given software application, and the vector representation captures characteristics of the application in a numerical format.

Accordingly, one or more embodiments include using one or more language models and open-source libraries to assist in encoding data in textual form to at least one numeric representation. Such numerical representation can describe, for example, a vector of hidden weights which a separate model generated for a custom downstream learning objective (e.g., predicting masked words in sentences).

At least one embodiment also includes calculating the cosine similarity between vectors representing different software applications. Such a cosine similarity calculation measures the cosine of the angle between two vectors and provides a value between −1 and 1, wherein 1 indicates a high degree of similarity and −1 indicates dissimilarity. The cosine of two non-zero vectors can be derived, for example, using the Euclidean dot product formula, as follows:

$$A \cdot B = ‖ A ‖ ‖ B ‖ cos θ$$

Given two n-dimensional vectors of attributes, A and B, the cosine similarity, cos θ, can be represented using a dot product and magnitude as follows:

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2} \cdot {\sum }_{i = 1}^{n} {B}_{i}^{2}}}$$

wherein Aᵢ and Bᵢ are the ith components of vectors A and B, respectively.

Additionally or alternatively, one or more embodiments include building and/or implementing a tree-based classifier using, for example, random forest techniques or other supervised machine learning algorithms, to identify and/or tag similar software applications (relative to a given application installed or to be installed on a given user's device) into substitute and complementary categories. Such identified and/or tagged similar software applications can then be used to prepare a LAR package providing the device user with LAR associated with removing, from the device, corresponding applications and installing, onto the device, the identified and/or tagged similar software applications.

In leveraging random forest techniques to generate a tree-based classifier, at least one embodiment includes modeling one or more input features. Considering each of multiple pairs of top similar applications, such an embodiment can include calculating cosine similarity scores for each pair in conjunction with a cosine similarity threshold score. The input features may include, for example, information about the applications' functionalities, the persona and/or teams associated with the applications, application-related compatibility, etc. Also, in one or more embodiments, the input features can be LLM embeddings of application1 and application2 based on the application name, generative descriptions of the application usage, and embeddings based at least in part on automatically generated content. Further, additional features can include identification of common personas which use the applications. By way merely of example, Dbeaver and Pgadmin are similar applications, both being used by software developers and data engineers interchangeably within an enterprise, alongside other developer tools.

At least one embodiment can also include assessing the performance of a tree-based classifier by measuring metrics such as, e.g., accuracy, precision, recall, and F1 score. Such an embodiment can additionally include interpreting the tree-based classifier to understand one or more learned classification rules and identifying one or more important features. Also, a trained tree-based classifier can be used to classify new applications as substitutes or complements (for existing applications) based at least in part on the application features thereof. For example, an application may be tagged as a substitute if the application is deemed to be a suitable replacement for another application. Further, an application may be tagged as complementary if the application complements and/or enhances the functionality of another application. Also, such classification labels can be assigned and used in furtherance of preparing at least one LAR package.

Accordingly, one or more embodiments include creating one or more LAR packages of administrator rights specifically limited to a set of one or more software application-related operations such as, for example, installing a predefined set of one or more applications on a given device, updating a predefined set of one or more applications on a given device, etc. Using such an LAR package, a user can automatically utilize the corresponding administrator rights and/or related capabilities to automate (e.g., through an online portal) one or more re-installation and/or installation workflows in connection with one or more software applications and a given device associated with the user.

As detailed herein, creating a LAR package, in accordance with one or more embodiments can include defining access policies and/or rules, developing an LAR tool, creating a configuration file, implementing access control logic, and packaging the LAR tool. Defining access policies and/or rules can include, for example, specifying which users or groups of users should have certain administrative rights, and what software applications such users are allowed to install and/or manage in connection with such policies and/or rules. Developing a LAR tool can include, for example, creating (using languages such as Python, C#, etc.) an LAR tool responsible for enforcing the access policies and/or rules and managing administrator rights.

Creating a configuration file (e.g., a JavaScript Object Notation (JSON) file, an extensible markup language (XML) file, etc.) can include creating a file that defines the access policies and/or rules, user roles, allowed applications, and one or more other relevant settings. Such a configuration file can serve as a rulebook for the LAR tool and its functionality, and the configuration file can be updated, for example, using one or more web services. Implementing access control logic within the LAR tool can include implementing logic which can read the configuration file and make decisions about granting administrator rights based at least in part on user requests and policies and/or rules. Further, packaging the LAR tool can include packaging the LAR tool as at least one executable file, and distributing the LAR package to one or more targeted users and/or administrators (e.g., through network shares, email, a software deployment system, etc.).

At least one embodiment can include implementation in industries that require a particular suite of applications to be installed in particular devices such as, for example, medical industries, educational industries, etc. In such industries, as well as others, one or more embodiments can include improving the productivity of users (e.g., by reducing the time and resources involved in obtaining and utilizing LAR to install and/or update software applications on devices).

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions of substitute and/or complementary software applications (relative to one or more particular software applications installed or to be installed on one or more given user devices) based on user data (role, experience, etc.) and/or application-related data (functionalities, version information, etc.), and such recommendations and/or predictions can be used to initiate one or more automated actions (e.g., automatically generating and outputting one or more LAR packages, automatically training and/or tuning one or more artificial intelligence techniques, etc.).

FIG. 5 is a flow diagram of a process for generating automated workflows associated with LAR using artificial intelligence techniques in an illustrative embodiment. It is to be understood that this particular process is only an example, and additional or alternative processes can be carried out in other embodiments.

In this embodiment, the process includes steps 500 through 506. These steps are assumed to be performed by the LAR-based automated workflow system 105 utilizing elements 112, 114, 116 and 118.

Step 500 includes obtaining data pertaining to a first set of one or more software applications in association with at least one user device. In at least one embodiment, obtaining data includes identifying a list of one or more software applications required for use by at least one user associated with the at least one user device. In such an embodiment, identifying the list of one or more software applications required for use by the at least one user associated with the at least one user device can include processing data pertaining to software applications used by one or more additional users related to the at least one user on a basis of one or more of user work domain, user work function, and user work experience.

Step 502 includes identifying, by processing, using one or more artificial intelligence techniques, data associated with one or more user devices related to the at least one user device, a second set of one or more software applications related to at least a portion of the first set of one or more software applications. In one or more embodiments, identifying a second set of one or more software applications related to at least a portion of the first set of one or more software applications includes determining at least one of one or more substitute software applications for the at least a portion of the first set of one or more software applications and one or more complimentary software applications to the at least a portion of the first set of one or more software applications. Also, in at least one embodiment, identifying a second set of one or more software applications related to the at least a portion of the first set of one or more software applications includes processing data pertaining to the at least a portion of the first set of one or more software applications and the multiple additional software applications using at least one random forest tree-based classifier.

Additionally or alternatively, identifying a second set of one or more software applications related to the at least a portion of the first set of one or more software applications can include determining one or more similarity values between the at least a portion of the first set of one or more software applications and the multiple additional software applications using one or more cosine similarity techniques. In such an embodiment, determining one or more similarity values can include processing, using the one or more cosine similarity techniques, one or more of attribute data associated with the at least a portion of the first set of one or more software applications and the multiple additional software applications, and functionality data associated with the at least a portion of the first set of one or more software applications and the multiple additional software applications. Also, in such an embodiment, determining one or more similarity values can include processing, using the one or more cosine similarity techniques, content pertaining to the at least a portion of the first set of one or more software applications and the multiple additional software applications automatically generated using one or more language models. Further, in such an embodiment, determining one or more similarity values can include representing each of the at least a portion of the first set of one or more software applications and the multiple additional software applications as a vector, and calculating similarity values between the vectors representing the at least a portion of the first set of one or more software applications and the multiple additional software applications.

Step 504 includes generating one or more automated workflows comprising one or more local administrator rights granted for the at least one user device, wherein the one or more automated workflows pertain to one or more operations to be carried out in connection with the at least one user device and at least one of the first set of one or more software applications and the second set of one or more software applications. In at least one embodiment, generating the one or more automated workflows includes granting one or more local administrator rights for installing at least a portion of the first set of one or more software applications on the at least one user device. Additionally or alternatively, generating the one or more automated workflows can include granting one or more local administrator rights for replacing at least a portion of the first set of one or more software applications with at least a portion of the second set of one or more software applications on the at least one user device. Also, in at least one embodiment, generating the one or more automated workflows includes granting one or more local administrator rights for updating one or more of at least a portion of the first set of one or more software applications and at least a portion of the second set of one or more software applications on the at least one user device.

Step 506 includes performing one or more automated actions based at least in part on the one or more automated workflows. In one or more embodiments, performing one or more automated actions includes initiating at least one of the one or more automated workflows on the at least one user device. Additionally or alternatively, performing one or more automated actions can include automatically training at least a portion of the one or more artificial intelligence techniques using feedback related to at least one of the one or more automated workflows.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate automated workflows associated with LAR using artificial intelligence techniques. These and other embodiments can effectively overcome problems associated with time-consuming and resource-intensive procedures.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

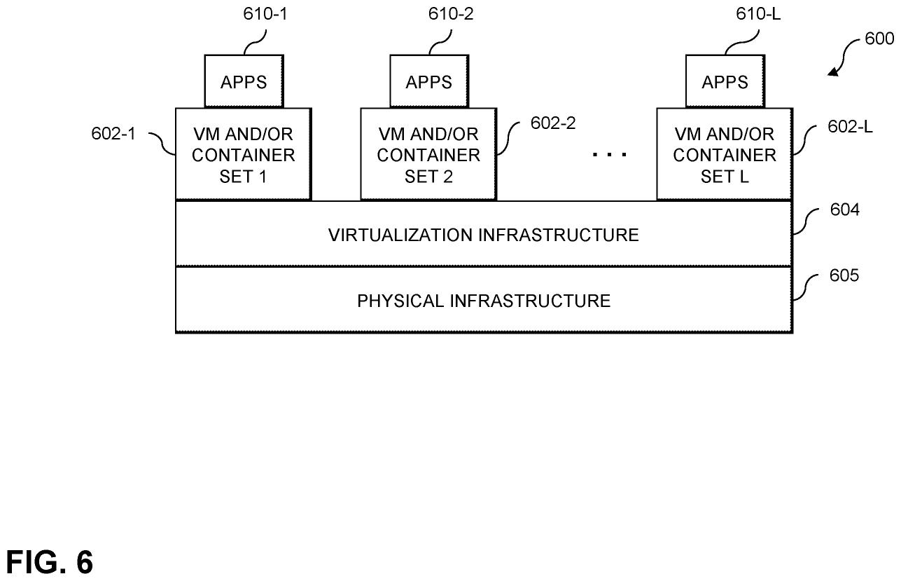

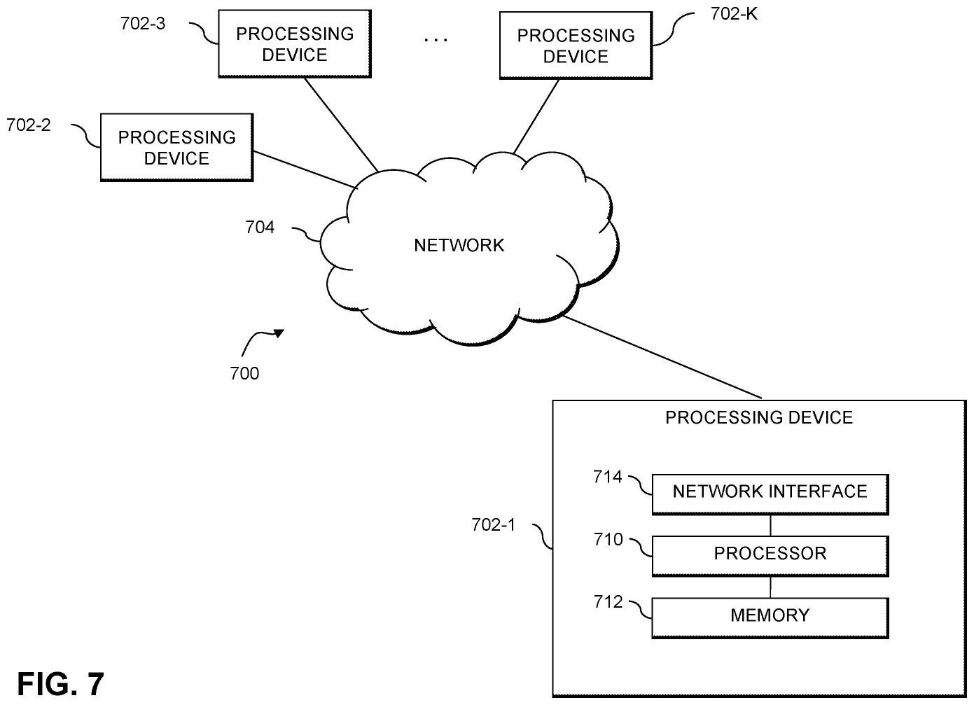

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data pertaining to a first set of one or more software applications in association with at least one user device;
identifying, by processing, using one or more artificial intelligence techniques, data associated with one or more user devices related to the at least one user device, a second set of one or more software applications related to at least a portion of the first set of one or more software applications;
generating one or more automated workflows comprising one or more local administrator rights granted for the at least one user device, wherein the one or more automated workflows pertain to one or more operations to be carried out in connection with the at least one user device and at least one of the first set of one or more software applications and the second set of one or more software applications; and
performing one or more automated actions based at least in part on the one or more automated workflows;
wherein the method is performed by at least one processing device comprising a processor coupled to a memory.

2. The computer-implemented method of claim 1, wherein generating the one or more automated workflows comprises granting one or more local administrator rights for installing at least a portion of the first set of one or more software applications on the at least one user device.

3. The computer-implemented method of claim 1, wherein generating the one or more automated workflows comprises granting one or more local administrator rights for replacing at least a portion of the first set of one or more software applications with at least a portion of the second set of one or more software applications on the at least one user device.

4. The computer-implemented method of claim 1, wherein generating the one or more automated workflows comprises granting one or more local administrator rights for updating one or more of at least a portion of the first set of one or more software applications and at least a portion of the second set of one or more software applications on the at least one user device.

5. The computer-implemented method of claim 1, wherein performing one or more automated actions comprises initiating at least one of the one or more automated workflows on the at least one user device.

6. The computer-implemented method of claim 1, wherein performing one or more automated actions comprises automatically training at least a portion of the one or more artificial intelligence techniques using feedback related to at least one of the one or more automated workflows.

7. The computer-implemented method of claim 1, wherein identifying a second set of one or more software applications related to at least a portion of the first set of one or more software applications comprises determining at least one of one or more substitute software applications for the at least a portion of the first set of one or more software applications and one or more complimentary software applications to the at least a portion of the first set of one or more software applications.

8. The computer-implemented method of claim 1, wherein identifying a second set of one or more software applications related to the at least a portion of the first set of one or more software applications comprises determining one or more similarity values between the at least a portion of the first set of one or more software applications and multiple additional software applications using one or more cosine similarity techniques.

9. The computer-implemented method of claim 8, wherein determining one or more similarity values comprises processing, using the one or more cosine similarity techniques, one or more of attribute data associated with the at least a portion of the first set of one or more software applications and the multiple additional software applications, and functionality data associated with the at least a portion of the first set of one or more software applications and the multiple additional software applications.

10. The computer-implemented method of claim 8, wherein determining one or more similarity values comprises processing, using the one or more cosine similarity techniques, content pertaining to the at least a portion of the first set of one or more software applications and the multiple additional software applications automatically generated using one or more language models.

11. The computer-implemented method of claim 8, wherein determining one or more similarity values comprises:
representing each of the at least a portion of the first set of one or more software applications and the multiple additional software applications as a vector; and
calculating similarity values between the vectors representing the at least a portion of the first set of one or more software applications and the multiple additional software applications.

12. The computer-implemented method of claim 1, wherein identifying a second set of one or more software applications related to the at least a portion of the first set of one or more software applications comprises processing data pertaining to the at least a portion of the first set of one or more software applications and multiple additional software applications using at least one random forest tree-based classifier.

13. The computer-implemented method of claim 1, wherein obtaining data comprises identifying a list of one or more software applications required for use by at least one user associated with the at least one user device.

14. The computer-implemented method of claim 13, wherein identifying the list of one or more software applications required for use by the at least one user associated with the at least one user device comprises processing data pertaining to software applications used by one or more additional users related to the at least one user on a basis of one or more of user work domain, user work function, and user work experience.

15. A non-transitory processor-readable storage medium having stored therein program code of one or more software programs, wherein the program code when executed by at least one processing device causes the at least one processing device:
to obtain data pertaining to a first set of one or more software applications in association with at least one user device;
to identify, by processing, using one or more artificial intelligence techniques, data associated with one or more user devices related to the at least one user device, a second set of one or more software applications related to at least a portion of the first set of one or more software applications;
to generate one or more automated workflows comprising one or more local administrator rights granted for the at least one user device, wherein the one or more automated workflows pertain to one or more operations to be carried out in connection with the at least one user device and at least one of the first set of one or more software applications and the second set of one or more software applications; and
to perform one or more automated actions based at least in part on the one or more automated workflows.

16. The non-transitory processor-readable storage medium of claim 15, wherein
generating the one or more automated workflows comprises granting one or more local administrator rights for installing at least a portion of the first set of one or more software applications on the at least one user device.

17. The non-transitory processor-readable storage medium of claim 15, wherein
performing one or more automated actions comprises initiating at least one of the one or more automated workflows on the at least one user device.

18. An apparatus comprising:
at least one processing device comprising a processor coupled to a memory;
the at least one processing device being configured:
to obtain data pertaining to a first set of one or more software applications in association with at least one user device;
to identify, by processing, using one or more artificial intelligence techniques, data associated with one or more user devices related to the at least one user device, a second set of one or more software applications related to at least a portion of the first set of one or more software applications;
to generate one or more automated workflows comprising one or more local administrator rights granted for the at least one user device, wherein the one or more automated workflows pertain to one or more operations to be carried out in connection with the at least one user device and at least one of the first set of one or more software applications and the second set of one or more software applications; and
to perform one or more automated actions based at least in part on the one or more automated workflows.

19. The apparatus of claim 18, wherein generating the one or more automated workflows comprises granting one or more local administrator rights for installing at least a portion of the first set of one or more software applications on the at least one user device.

20. The apparatus of claim 18, wherein performing one or more automated actions comprises initiating at least one of the one or more automated workflows on the at least one user device.
